(19) United States
(12) Patent Application Publication
(10) Pub. No.: US 2020/0408631 A1
(43) Pub. Date: Dec. 31, 2020

(54) CONTROLLER FOR EVALUATING INERTIA AND INERTIA EVALUATION METHOD

(71) Applicant: FANUC CORPORATION, Minamitsuru-gun (JP)

(72) Inventors: Shougo SHINODA, Yamanashi (JP); Satoshi IKAI, Yamanashi (JP)

(21) Appl. No.: 16/865,558

(22) Filed: May 4, 2020

(30) Foreign Application Priority Data
Jun. 25, 2019 (JP) 2019-117539

(51) Int. Cl. G01M 1/10; G01M 17/007; G01C 25/00; B60W 10/08

(52) U.S. Cl. CPC G01M 1/10; G01M 17/007; B60W 2510/084; B60W 10/08; B60W 2510/088; G01C 25/005

(57) ABSTRACT

A controller (100, 100A) for easily evaluating validity of inertia is provided. A controller (100, 100A) includes: an electric motor (300); an actual operation acquisition unit (301) that acquires an actual operation of the electric motor (300); a model unit (108) that estimates an operation of the electric motor (300) from a current value applied to the electric motor (300) using a model including inertia of the electric motor (300) and a driven body (400) connected to the electric motor (300); an operation signal input unit (106) that applies an operation signal to a control loop of the electric motor (300) for a prescribed period; and an evaluation value calculation unit (111) that calculates an evaluation value for evaluating the inertia on the basis of a difference between an actual operation and an estimated operation in the application period of the operation signal.

This application is based on and claims the benefit of priority from Japanese Patent Application No. 2019-117539, filed on 25 Jun. 2019, the content of which is incorporated herein by reference.

### BACKGROUND OF THE INVENTION

### Field of the Invention

The present invention relates to a controller for evaluating inertia and an inertia evaluation method.

### Related Art

A controller for estimating inertia is disclosed in Patent Document 1. Moreover, a controller that calculates an inverse model of a transfer function of a control target including inertia and friction to calculate a torque correction value using the inverse model and a velocity command is disclosed in Patent Document 2. Specifically, Patent Document 1 discloses a controller in which an inertia estimation unit of a servo controller of an electric motor includes: a sinusoidal command generation unit that adds a sinusoidal command to a torque command to an electric motor, a current feedback sampling unit that samples a current value flowing into the electric motor, a velocity feedback sampling unit that samples a velocity feedback of the electric motor, an acceleration value calculation unit that calculates an acceleration from the velocity feedback, and an estimated inertia calculation unit that calculates inertia from a representative current value and a representative acceleration value obtained from current values and acceleration values over a plurality of periods of the sinusoidal command, and a torque constant of the electric motor, stored in a sampling data storage unit.

Patent Document 2 discloses a controller in which a motor controller that controls a motor that drives a control target includes: a velocity feedback control unit that calculates a non-corrected torque command for controlling an actual velocity of a control target so as to track an input velocity command, an inverse model calculation unit that calculates an inverse model of a transfer function including inertia and friction of the control target using the velocity command and the non-corrected torque command, a torque correction value generation unit that generates a torque correction value using the inverse model of the velocity command, and a torque command generation unit that generates a torque command for the motor that drives a control target using the non-corrected torque command and the torque correction value.
Patent Document 1: Japanese Unexamined Patent Application, Publication No. 2010-148178
Patent Document 2: Japanese Unexamined Patent Application, Publication No. 2015-15844

### SUMMARY OF THE INVENTION

When parameters dependent on inertia are set, a controller and an inertia evaluation method for easily evaluating validity of inertia are desirable.

(1) A first aspect of the present disclosure provides a controller including: an electric motor; an actual operation acquisition unit that acquires an actual operation of the electric motor; a model unit that estimates an operation of the electric motor from a current value applied to the electric motor using a model including inertia of the electric motor and a driven body connected to the electric motor; an operation signal input unit that applies an operation signal to a control loop of the electric motor for a prescribed period; and an evaluation value calculation unit that calculates an evaluation value for evaluating the inertia on the basis of a difference between an actual operation and an estimated operation in the application period of the operation signal.

(2) A second aspect of the present disclosure provides a control system including: the controller; and a host device connected to the controller, wherein the controller includes an inertia correction unit that corrects the inertia of the electric motor and the driven body on the basis of the evaluation value, the host device includes: a receiving unit that receives corrected inertia transmitted from the controller; and a changing unit that changes settings of at least one of a time constant of an acceleration/deceleration command of the electric motor, a velocity gain, a velocity feedforward, an inverse model of an observer, an attenuation frequency of a filter, and a torque limitation value, which are inertia-dependent parameters, on the basis of the received inertia.

(3) A third aspect of the present disclosure provides an inertia evaluation method of a controller that controls an electric motor, the method including: applying an operation signal to a control loop of the electric motor for a prescribed period; acquiring an actual operation of the electric motor; estimating an operation of the electric motor from a current value applied to the electric motor using a model including inertia of the electric motor and a driven body connected to the electric motor; and calculating an evaluation value for evaluating the inertia on the basis of a difference between an actual operation and an estimated operation in the application period of the operation signal.

According to the aspects of the present disclosure, it is possible to easily evaluate validity of inertia.

### BRIEF DESCRIPTION OF THE DRAWINGS

FIG. 1 is a block diagram illustrating a configuration example of a control system including a controller according to a first embodiment of the present disclosure.

FIG. 2 is a block diagram illustrating a portion of a machine tool including a motor, serving as an example of an electric motor and a driven body of a controller.

FIG. 3 is a characteristic diagram illustrating a relationship between a velocity ω and a nonlinear friction F.

FIG. 4 is a block diagram illustrating a configuration of a host device.

FIG. 5 is a flowchart illustrating an example of an operation of the controller according to the first embodiment.

FIG. 6 is a flowchart illustrating another example of the operation of the controller according to the first embodiment.

FIG. 7 is a flowchart illustrating still another example of the operation of the controller according to the first embodiment.

FIG. 8 is a block diagram illustrating a configuration example of a control system including a controller according to a second embodiment of the present disclosure.

FIG. 9 is a block diagram illustrating a configuration of a host device.

### DETAILED DESCRIPTION OF THE INVENTION

Hereinafter, embodiments of the present disclosure will be described.

### First Embodiment

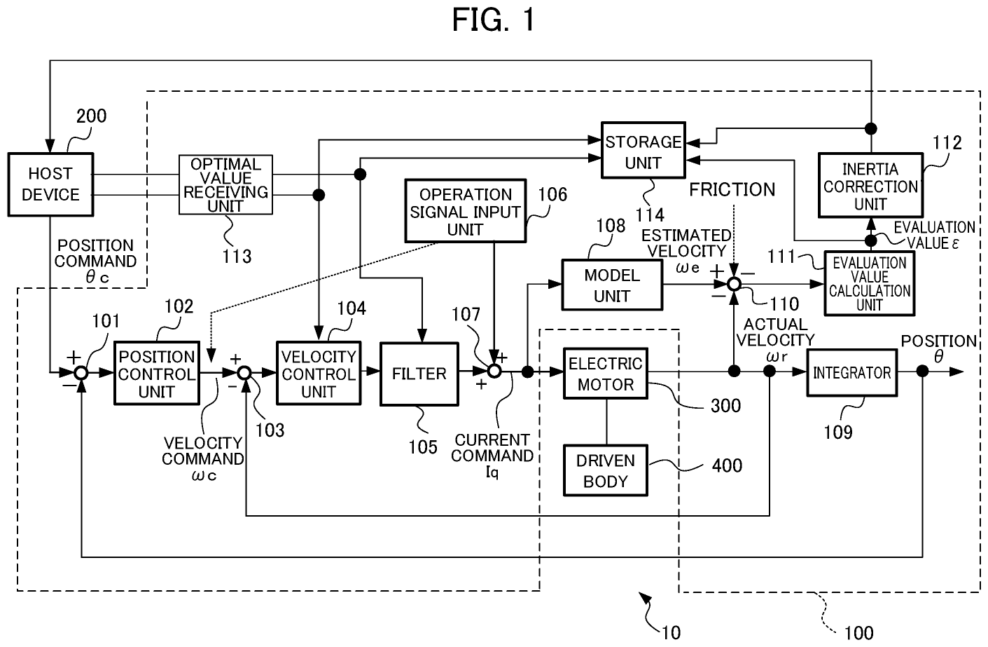

FIG. 1 is a block diagram illustrating a configuration example of a control system including a controller according to a first embodiment of the present disclosure.

As illustrated in FIG. 1, a control system 10 includes a controller 100, a host device 200 that outputs a position command θc to the controller 100, an electric motor 300 driven by the controller 100, and a driven body 400 connected to the electric motor 300. The controller 100 includes a subtractor 101, a position control unit 102, a subtractor 103, a velocity control unit 104, a filter 105, an operation signal input unit 106, an adder 107, a model unit 108, an integrator 109, a subtractor 110, an evaluation value calculation unit 111, an inertia correction unit 112, an optimal value receiving unit 113, and a storage unit 114.

The position command θc is output to the subtractor 101. The position command θc is calculated by the host device 200 on the basis of a program for operating the electric motor 300. The subtractor 101 calculates a difference between the position command θc and a position feedback detection position G and outputs the difference to the position control unit 102 as a position error. The position control unit 102 outputs a value obtained by multiplying the position error by a position gain Kp to the subtractor 103 as a velocity command ω_{c}. The subtractor 103 calculates a difference between the velocity command ωc and a velocity feedback detection velocity (actual velocity) ωr and outputs the difference to the velocity control unit 104 as a velocity error.

The velocity control unit 104 adds a value obtained by multiplying and integrating the velocity error by an integral gain K1v and a value obtained by multiplying the velocity error by a proportional gain K2v and outputs the addition value to the filter 105 as a current command.

The filter 105 is a filter (for example, a notch filter or a low-pass filter) for attenuating a specific frequency component and outputs a filtered current command to the adder 107. The driven body 400 such as a machine tool driven by the electric motor 300 has a resonance point and the controller 100 may increase resonance. In this case, the resonance can be decreased using a notch filter, for example.

The operation signal input unit 106 generates an operation signal and inputs the operation signal to the adder 107 for a prescribed period. As described later, the prescribed period is a period in which a prescribed period has elapsed and a velocity error has settled after an operation signal was input to the adder 107, and the evaluation value calculation unit 111 to be described later integrates a difference between an estimated velocity ωe and the detection velocity ωr for (N+1) times from n=0 to n=N (N is a natural number). The velocity control unit 104, the filter 105, the adder 107, and the electric motor 300 form a velocity control loop serving as a control loop. The operation signal is a sinusoidal signal having a frequency (for example, a low frequency of approximately 25 Hz to 100 Hz) equal to or smaller than a control range of the electric motor 300. The frequency of 25 Hz to 100 Hz is an example and is not limited to this range. The operation signal is not limited to a sinusoidal wave but may be another signal such as a rectangular wave. The operation signal may be added to the velocity command ω_{c} instead of being added to the current command output from the filter 105 via the adder 107. In FIG. 1, an operation signal added to the velocity command ω_{c} is indicated by a broken line.

The adder 107 adds the current command output from the filter 105 and the operation signal output from the operation signal input unit 106 and inputs the addition value to the electric motor 300 as a current command Iq. Moreover, the adder 107 inputs the current command Iq to the model unit 108. The current command output from the filter 105 is a fixed value when the operation signal is input to the adder 107.

The electric motor 300 is a servo motor, a spindle motor, or the like. Although the servo motor is described as a motor of which the axis rotates, the servo motor may be a linear motor. The driven body 400 is a machine such as a machine tool, a robot, or an industrial machine driven by the electric motor 300. The electric motor 300 and the driven body 400 are control targets of the controller 100. The electric motor 300 may be included in a machine such as a machine tool, a robot, or an industrial machine.

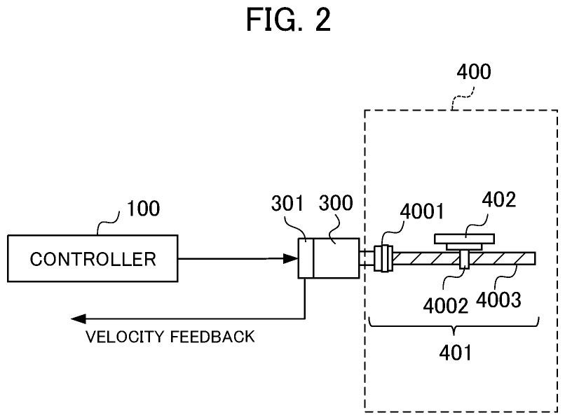

FIG. 2 is a block diagram illustrating a portion of a machine tool including a motor, serving as an example of the electric motor 300 and the driven body 400 of the controller 100. The controller 100 moves a table 402 with the aid of a coupling mechanism 401 of a driven body 400 using the electric motor 300 to thereby machine a workpiece mounted on the table 402. The coupling mechanism 401 has a coupling 4001 connected to the electric motor 300 and a ball screw 4003 fixed to the coupling 4001, and a nut 4002 is screwed to the ball screw 4003. With rotation of the electric motor 300, the nut 4002 screwed to the ball screw 4003 moves in an axial direction of the ball screw 4003. The table 402 moves with movement of the nut 4002.

A rotational angular position of the electric motor 300 is detected by a rotary encoder 301 associated with the electric motor 300, and a detection velocity (actual velocity) ωr obtained by the rotational angular position is input to the subtractor 103 and the subtractor 110 as a velocity feedback (velocity FB). The rotary encoder 301 serves as an actual operation acquisition unit. An actual operation serves as a detection velocity. When a linear motor is used, a velocity is detected using a linear scale serving as an actual operation acquisition unit. The detection velocity ωr is integrated by the integrator 109 and a detection position θ is obtained, and the detection position θ is input to the subtractor 101 as a position feedback (position FB).

A transfer function of the electric motor 300 and the driven body 400 is represented by Expression 1 (Math. 1 below). In Expression 1, J indicates total inertia, Kt indicates a torque constant, and F indicates nonlinear friction. The total inertia J is the sum of inertia of an electric motor and inertia of a machine.

$$\frac{{K}_{t}}{J \cdot s + F} \qquad [ Math . 1 ]$$

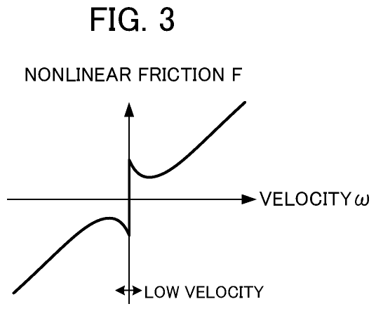

The nonlinear friction F is represented by F(ω)=V(ω)+C·sign(ω)/ω. V(ω) indicates viscous friction, C indicates Coulomb friction, and ω indicates velocity. The function sign(ω) is a sign function of the velocity ω and indicates the polarity of the velocity ω. sign(ω)=1 when the velocity ω is positive, sign(ω)=0 when the velocity ω is 0, and sign(ω)=−1 when the velocity ω is negative. FIG. 3 is a characteristic diagram illustrating a relationship between a velocity ω and a nonlinear friction F. Since the viscous friction V(ω) is approximately proportional to the velocity ω, when the electric motor moves at a low velocity as illustrated in FIG. 3, Coulomb friction C·sign(ω) is dominant in the nonlinear friction F. When the operation signal of the operation signal input unit 106 is a low-frequency signal and the electric motor is operated at a low velocity, the influence of the viscous friction V(ω) can be made negligible. For example, as described above, a sinusoidal signal having a low frequency of approximately 25 Hz to 100 Hz is used as the operation signal.

The model unit 108 calculates the estimated velocity ωe on the basis of the current command Iq and outputs the estimated velocity ωe to the subtractor 110. A transfer function of the model unit 108 is represented by Expression 2 (Math. 2 below), and a nonlinear friction is not taken into consideration. J is a total inertia, Kt is a torque constant, and “\hat{ }” (referred to as a hat or a caret) above J and Kt indicates an average value (a nominal value) of the value detected by a measuring device or the like.

$$\frac{\hat{J} \cdot s}{} \qquad [ Math . 2 ]$$

An inverse model of the electric motor 300 and the driven body 400 is defined by Expression 3 (Math. 3 below). T represents a sampling period. n indicates the number of sampling data and is a natural number of 1 or more. A torque constant Kt in Math. 3 indicates the nominal value of the torque constant Kt in Math. 2. A total inertia J in Math. 3 indicates a nominal value of the total inertia J or a corrected total inertia J. The total inertia J in Math. 3 is corrected on the basis of an evaluation value ε calculated by the evaluation value calculation unit 111.

$${i}_{q} ( n ) = \frac{J}{Kt \cdot T} ( {ω}_{e} ( n ) - {ω}_{e} ( n - 1 ) ) \qquad [ Math . 3 ]$$

Expression 3 is modified to an equation represented by Expression 4 (Math. 4 below). An estimated velocity ωe(n) can be calculated on the basis of the sum of a (Kt·T)/J multiple of an integration value of the current command Iq and an initial value ωe(0) of the estimated velocity.

$$\begin{matrix}{ω}_{e} ( n ) = \frac{Kt \cdot T}{J} {i}_{q} ( n ) + {ω}_{e} ( n - 1 ) \\ = \frac{Kt \cdot T}{J} {i}_{q} ( n ) + \frac{Kt \cdot T}{J} {i}_{q} ( n - 1 ) + {ω}_{e} ( n - 2 ) \\ = \frac{Kt \cdot T}{J} \sum {i}_{q} ( n ) + {ω}_{e} ( 0 )\end{matrix} \qquad [ Math . 4 ]$$

The subtractor 110 outputs a difference between the estimated velocity ωe output from the model unit 108 and a detection velocity ωr. When a nonlinear friction is taken into consideration, the subtractor 110 further subtracts a nonlinear friction term ζ(ωr) from the difference between the estimated velocity ωe and the detection velocity ωr. The nonlinear friction term ζ(ωr) can be approximated as follows. From Expression 1, ωr(n)=(Kt/(J·s+F))×Iq. When the electric motor 300 is operated at a low velocity and the viscous friction V of the nonlinear friction F can be negligible, (J·s)×ωr(n)+C×sign(ωr)=Kt×Iq and ωr(n) is represented by Expression 5 (Math. 5 below).

$${ω}_{r} ( n ) = \frac{{K}_{t} \times {i}_{q}}{J \cdot s} - \frac{C \cdot sign ( {ω}_{r} ( n ) )}{ J \cdot s} \qquad [ Math . 5 ]$$

Therefore, the nonlinear friction term ζ(ωr) can be approximated as (C·sign(ωr))/(J·s) in Expression 5. When the nonlinear friction is not taken into consideration, the evaluation value calculation unit 111 calculates an integration (sum) of an absolute value of the difference between the estimated velocity ωe and the detection velocity ωr as illustrated in Expression 6 (Math. 6 below), and the integration value is output to the inertia correction unit 112 and the storage unit 114 as an evaluation value ε. The difference between the estimated velocity ωe and the detection velocity ωr is calculated after a prescribed period has elapsed and a velocity error has settled after the operation signal was input to the adder 107 by the operation signal input unit 106, and an integration (sum) is calculated for (N+1) times from n=0 to n=N. N indicates the number of pieces of sampling data in one sampling period and is a natural number equal to or greater than one.

$$ɛ = {\sum }_{n = 0}^{N} \vert {ω}_{e} ( n ) - {ω}_{r} ( n ) \vert \qquad [ Math . 6 ]$$

An evaluation value when a nonlinear friction is not taken into consideration is not limited to the evaluation value calculated by Expression 3, but as illustrated in Expression 7 (Math. 7 below), an integration (sum) of the square of the absolute value of the difference between the estimated velocity ωe and the detection velocity ωr may be calculated and the integration value may be output as the evaluation value ε.

$$ɛ = {\sum }_{n = 0}^{N} {\vert {ω}_{e} ( n ) - {ω}_{r} ( n ) \vert}^{2} \qquad [ Math . 7 ]$$

When the nonlinear friction is taken into consideration, the evaluation value calculation unit 111 calculates an integration (sum) of the absolute value of a value obtained by subtracting the nonlinear friction term ζ(ωr) from the difference between the estimated velocity ωe and the detection velocity ωr as illustrated in Expression 8 (Math. 8 below) and outputs the integration value as an evaluation value ε.

$$ɛ = {\sum }_{n = 0}^{N} \vert {ω}_{e} ( n ) - {ω}_{r} ( n ) - ζ ( {ω}_{r} ( n ) ) \vert \qquad [ Math . 8 ]$$

The evaluation value when the nonlinear friction is not taken into consideration is not limited to the evaluation value calculated by Expression 8, but as illustrated in Expression 9 (Math. 9 below), an integration (sum) of the square of the absolute value of a value obtained by subtracting the nonlinear friction term ζ(ωr) from the difference between the estimated velocity ωe and the detection velocity ωr may be calculated and the integration value may be output as an evaluation value ε.

$$ɛ = {\sum }_{n = 0}^{N} {\vert {ω}_{e} ( n ) - {ω}_{r} ( n ) - ζ ( {ω}_{r} ( n ) ) \vert}^{2} \qquad [ Math . 9 ]$$

The inertia correction unit 112 evaluates the validity of the total inertia J of the model unit 108 according to the evaluation value ε calculated by the evaluation value calculation unit 111. Specifically, a total inertia (hereinafter referred to as a corrected inertia) J that minimizes the evaluation value ε which is a function of the total inertia J is calculated. The corrected inertia J calculated by the inertia correction unit 112 is output to the host device 200 and the storage unit 114. The host device 200 calculates an optimal time constant of acceleration/deceleration, an optimal velocity gain, and a resonance frequency using the corrected inertia J as will be described later.

The optimal value receiving unit 113 receives the optimal time constant of acceleration/deceleration, the optimal velocity gain, and the resonance frequency from the host device 200 and stores the same in the storage unit 114, and changes the settings of the velocity control unit 104 and the filter 105 on the basis of the optimal time constant of acceleration/deceleration, the optimal velocity gain, and the resonance frequency.

The storage unit 114 stores at least one of the total inertia before correction, the corrected inertia, the values before and after change of the optimal time constant of acceleration/deceleration, the optimal velocity gain, and the resonance frequency, and the evaluation value ε. At least one of the total inertia before correction, the corrected inertia, the values before and after change of the optimal time constant of acceleration/deceleration, the optimal velocity gain, and the resonance frequency, and the evaluation value stored in the storage unit 114 may be transmitted to the outside of the controller 100 by a transmitting unit serving as an information notification unit (not shown). At least one of the total inertia before correction, the corrected inertia, the values before and after change of the optimal time constant of acceleration/deceleration, the optimal velocity gain, and the resonance frequency, and the evaluation value ε may be displayed on a display unit such as a liquid crystal display provided in the controller 100. The display unit also forms an information notification unit. The information notification unit is not particularly limited to a transmitting unit and a display unit as long as it can notify users of at least one of the total inertia before correction, the corrected inertia, the values before and after change of the optimal time constant of acceleration/deceleration, the optimal velocity gain, and the resonance frequency, and the evaluation value ε.

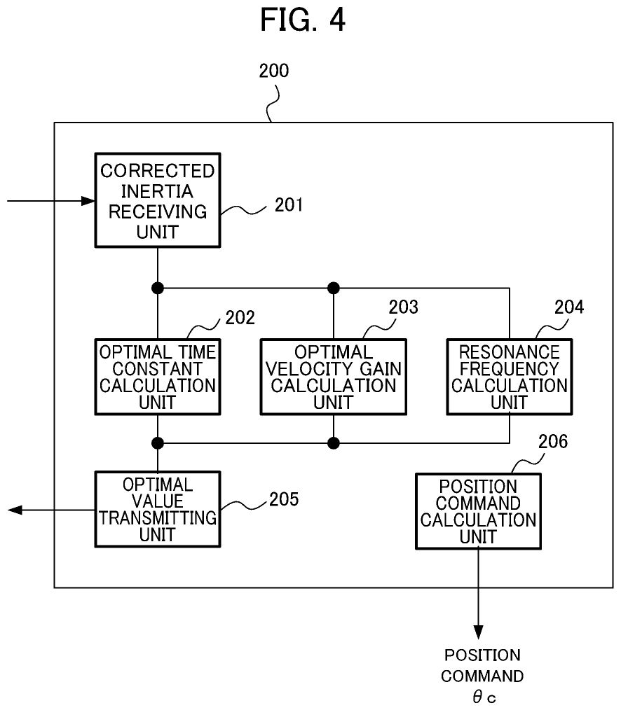

FIG. 4 is a block diagram illustrating a configuration of a host device. As illustrated in FIG. 4, the host device 200 includes a corrected inertia receiving unit 201, an optimal time constant calculation unit 202, an optimal velocity gain calculation unit 203, a resonance frequency calculation unit 204, an optimal value transmitting unit 205, and a position command calculation unit 206. The optimal time constant calculation unit 202, the optimal velocity gain calculation unit 203, and the resonance frequency calculation unit 204 are changing units that change the settings of the time constant of an acceleration/deceleration command, the velocity gain, and the attenuation frequency of a filter of the electric motor 300.

The corrected inertia receiving unit 201 receives the corrected inertia from the inertia correction unit 112, and the optimal time constant calculation unit 202, the optimal velocity gain calculation unit 203, and the resonance frequency calculation unit 204 receive the corrected inertia to calculate the optimal time constant of acceleration/deceleration, the optimal velocity gain, and the resonance frequency, respectively. The optimal time constant calculation unit 202, the optimal velocity gain calculation unit 203, and the resonance frequency calculation unit 204 output the calculated optimal time constant of acceleration/deceleration, the optimal velocity gain, and the resonance frequency to the optimal value receiving unit 113 of the controller 100 via the optimal value transmitting unit 205, respectively. The position command calculation unit 206 calculates a position command θc on the basis of a program for operating the electric motor 300 and outputs the calculated position command θc to the controller 100.

The host device 200 may be provided separately from a device including the position command calculation unit 206. In this case, the host device 200 does not include the position command calculation unit 206.

Hereinafter, a relationship between a total inertia, a time constant of acceleration/deceleration, a velocity gain, and a resonance frequency will be described. When the time constant of acceleration/deceleration is too short in relation to the total inertia of the driven body 400 and the electric motor 300, it is not possible to realize a commanded acceleration/deceleration with the ability of the electric motor 300, an output torque saturates with respect to a command torque, and it is not possible to perform normal control. Moreover, when the time constant of the acceleration/deceleration is too long in relation to the total inertia of the driven body 400 and the electric motor 300, the ability of the electric motor 300 is not exhibited sufficiently and the electric motor 300 is accelerated or decelerated more slowly than necessary.

Therefore, the time constant of acceleration/deceleration is adjusted optimally on the basis of the corrected inertia so that acceleration/deceleration which is as fast as possible is realized by the electric motor 300 according to the total inertia.

If the velocity gain is too small in relation to the total inertia of the driven body 400 and the electric motor 300, the velocity of the electric motor 300 cannot track a command value and stable control cannot be performed. Moreover, if the velocity gain is too large in relation to the total inertia of the driven body 400 and the electric motor 300, vibration may occur.

Therefore, by adjusting the velocity gain optimally on the basis of the corrected inertia, the velocity control unit 104 can adjust the velocity appropriately.

The optimal time constant and the optimal velocity gain may be calculated using an ordinary method such as approximating a relationship with inertia using a function and storing the same as a table, and supplementing the table as necessary.

When mechanical resonance occurs in the electric motor 300, since an adverse effect such as instable operation occurs, the filter 105 for preventing resonance is provided in the controller 100. Here, the resonance frequency f changes according to the inertia of the driven body 400. That is, when the inertia of the electric motor 300 is Jm, the inertia of the driven body 400 is J_{L}, and torsional rigidity between them is Ks, the resonance frequency f is calculated by Expression 10 (Math. 10 below). The inertia Jm of the electric motor may be calculated in advance theoretically or experimentally and the inertia J_{L} of the driven body 400 may be calculated from the inertia Jm and the corrected inertia.

$$f = \sqrt{\frac{{K}_{s}}{{J}_{L}} ( \frac{{J}_{L} + {J}_{m}}{{J}_{m}} )} \qquad [ Math . 10 ]$$

Therefore, it is possible to calculate the resonance frequency f according to Expression 10 from the corrected inertia to set the attenuation frequency of the filter 105.

The host device 200 may include one or two calculation units among the optimal time constant calculation unit 202, the optimal velocity gain calculation unit 203, and the resonance frequency calculation unit 204. In this case, the controller 100 may include one of the velocity control unit 104 and the filter 105.

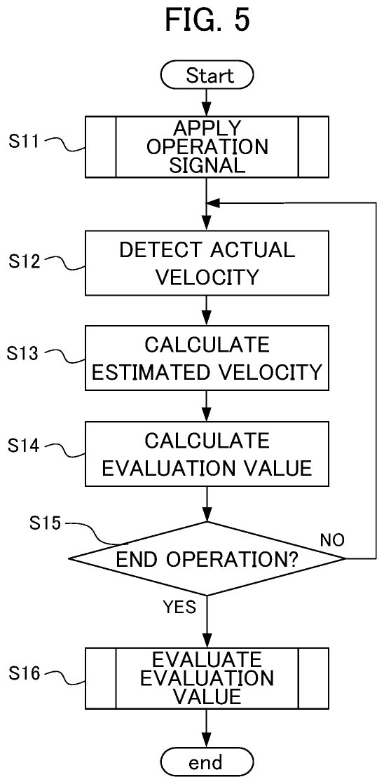

FIG. 5 is a flowchart illustrating an example of an operation of the controller.

In step S11, the operation signal input unit 106 inputs an operation signal to the adder 107.

In step S12, the detection velocity (actual velocity) ωr is detected by the rotational angular position detected by the rotary encoder 301.

In step S13, the model unit 108 calculates the estimated velocity ωe on the basis of the current command Iq.

In step S14, the evaluation value calculation unit 111 calculates an evaluation value (for example, the evaluation value ε illustrated in Expression 3) using the difference between the estimated velocity ωe and the detection velocity ωr output from the subtractor 110.

In step S15, when the evaluation value has not reached a prescribed number (No), the evaluation value calculation unit 111 changes the value of the total inertia of the model unit 108 and returns to step S12. When the evaluation value has reached the prescribed number, the evaluation value calculation unit 111 ends the operation of calculating the evaluation value (Yes) and evaluates the evaluation value in step S16 to calculate the total inertia (corrected inertia) when the evaluation value is the smallest. The total inertia of the model unit 108 is set to the corrected inertia when the evaluation value is the smallest and the corrected inertia when the evaluation value is the smallest is transmitted to the host device 200.

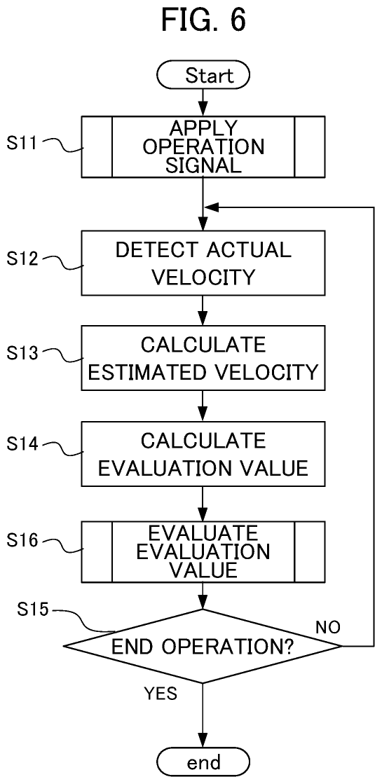

FIG. 6 is a flowchart illustrating another example of the operation of the controller. The operation illustrated in FIG. 6 is different from the operation illustrated in FIG. 5 in that the order of steps S15 and S16 is reversed. That is, the evaluation value is evaluated in step S16 subsequently to step S14, and when the evaluation value is smaller than the previous evaluation value obtained in step S16, the total inertia of the model unit 108 is not changed. When the evaluation value is larger than the previous evaluation value obtained in step S16, the total inertia of the model unit 108 is returned to the previous total inertia.

Step S15 is performed subsequently to step S16, and when the evaluation value has not reached the prescribed number (No), the evaluation value calculation unit 111 changes the value of the total inertia of the model unit 108 and returns to step S12. When the evaluation value has reached the prescribed number, the evaluation value calculation unit 111 ends the operation of calculating the evaluation value (Yes). Since the total inertia of the model unit when the operation ends is the corrected inertia when the evaluation value is the smallest, the total inertia is transmitted to the host device 200 as the corrected inertia.

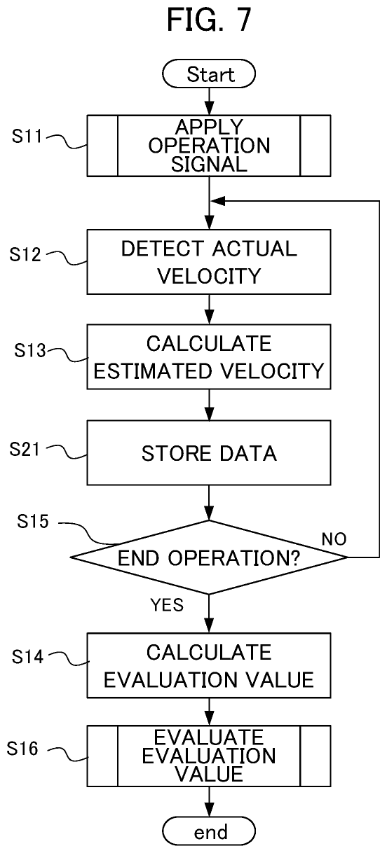

FIG. 7 is a flowchart illustrating still another example of the operation of the controller. The operation illustrated in FIG. 7 is different from the operation illustrated in FIG. 5 in that the data of the actual velocity and the estimated velocity is stored in step S21 subsequently to step S13, and thereafter, the processing is performed in the order of steps S15, S14, and S16.

In step S21, the evaluation value calculation unit 111 stores the data of the actual velocity and the estimated velocity in a storage unit such as a memory in the evaluation value calculation unit 111 in association with the value of the total inertia of the model unit 108. After that, in step S15, when the actual velocity and the estimated velocity have not reached a prescribed number (No), the evaluation value calculation unit 111 changes the value of the total inertia of the model unit 108 and returns to step S12. In step S15, when the actual velocity and the estimated velocity have reached the prescribed number (Yes), the evaluation value calculation unit 111 proceeds to step S14.

In step S14, the evaluation value calculation unit 111 reads the estimated velocity ωe and the detection velocity ωr from the storage unit and calculates the evaluation value (for example, the evaluation value illustrated in Expression 3) using the difference between the estimated velocity ωe and the detection velocity ωr.

In step S16, the evaluation value is evaluated and the total inertia when the evaluation value is the smallest is calculated. The total inertia of the model unit 108 is set to the total inertia when the evaluation value is the smallest, and the total inertia (a corrected inertia) when the evaluation value is the smallest is transmitted to the host device 200.

In the control system 10, the optimal time constant calculation unit 202, the optimal velocity gain calculation unit 203, and the resonance frequency calculation unit 204 provided in the host device 200 may be provided in the controller 100, the corrected inertia may be output from the inertia correction unit 112 in the controller 100 to the optimal time constant calculation unit 202, the optimal velocity gain calculation unit 203, and the resonance frequency calculation unit 204, and the settings of the velocity control unit 104 and the filter 105 may be changed on the basis of the optimal time constant of acceleration/deceleration, the optimal velocity gain, and the resonance frequency calculated by the optimal time constant calculation unit 202, the optimal velocity gain calculation unit 203, and the resonance frequency calculation unit 204. In this case, the corrected inertia receiving unit 201 and the optimal value transmitting unit 205 of the host device 200 are not necessary, and the optimal value receiving unit 113 of the controller 100 is not necessary. The controller 100 may include one or two calculation units among the optimal time constant calculation unit 202, the optimal velocity gain calculation unit 203, and the resonance frequency calculation unit 204. In this case, the controller 100 may include one of the velocity control unit 104 and the filter 105.

In the present embodiment, the actual operation and the estimation operation are an actual velocity and an estimated velocity and may be an actual position and an estimated position or an actual acceleration and an estimated acceleration.

In the present embodiment, it is possible to easily evaluate the validity of a total inertia using the model unit, the subtractor that takes a difference between the actual velocity and the estimated velocity output from the model unit, and the evaluation value calculation unit that calculates the evaluation value on the basis of the difference between the actual velocity and the estimated velocity. Moreover, it is possible to set inertia-dependent parameters (for example, a time constant of acceleration/deceleration, a velocity gain, and a resonance frequency) on the basis of the total inertia evaluated to be valid.

### Second Embodiment

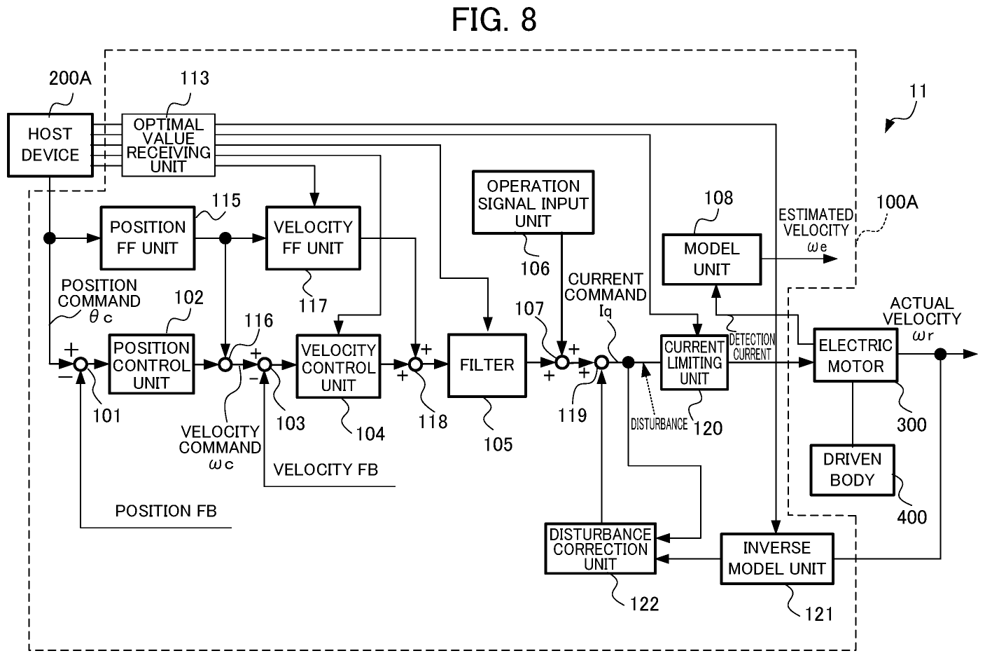

FIG. 8 is a block diagram illustrating a configuration example of a control system including a controller according to a second embodiment of the present disclosure.

A control system 11 of the present embodiment includes a controller 100A, a host device 200A that outputs a position command θc to the controller 100A, an electric motor 300 driven by the controller 100A, and a driven body 400 connected to the electric motor 300.

Although the controller 100A includes the same constituent components as those of the controller 100 illustrated in FIG. 1, the integrator 109, the evaluation value calculation unit 111, the inertia correction unit 112, and the storage unit 114 are not shown in FIG. 8 for the sake of simplicity. The controller 100A further includes a position feedforward unit (position FF unit) 115, an adder 116, a velocity feedforward unit (velocity FF unit) 117, an adder 118, a subtractor 119, a current limiting unit 120, an inverse model unit 121, and a disturbance correction unit 122 in addition to the controller 100 illustrated in FIG. 1.

Although the model unit 108 of the controller 100 illustrated in FIG. 1 calculates the estimated velocity ωe on the basis of the current command Iq, the model unit 108 of the controller 100A illustrated in FIG. 8 calculates the estimated velocity ωe on the basis of the detection current (serving as an actual current) output from a current detector attached to the electric motor 300 or an amplifier that drives the electric motor 300. Naturally, in the controller 100 illustrated in FIG. 1, instead of calculating the estimated velocity ωe on the basis of the current command Iq, the estimated velocity ωe may be calculated on the basis of the detection current (serving as an actual current) output from a current detector attached to the electric motor 300 or an amplifier that drives the electric motor 300.

The position feedforward unit 115 differentiates the position command θc, multiplies the same by a feedforward coefficient, and outputs the multiplication value to the adder 116 and the velocity feedforward unit 117. The adder 116 adds the output of the position feedforward unit 115 to the output of the position control unit 102 and outputs the addition value to the subtractor 103 as a velocity command ω_{c}.

The transfer function of the velocity feedforward unit 117 is set to an inverse function (J·s+F)/Kt of the transfer function of the driven body 400 and the electric motor 300 in order to realize high responsive control with respect to the velocity command.

The adder 118 adds the output of the velocity feedforward unit 117 to the output of the velocity control unit 104 and outputs the addition value to the filter 105 as a current command.

The adder 107 adds the current command and the operation signal output from the operation signal input unit 106 and outputs the addition value to the subtractor 110.

The subtractor 119 takes a difference between the output of the adder 107 and the output of the disturbance correction unit 122 and outputs the difference to the current limiting unit 120. The current limiting unit 120 applies a limitation to the current to be output to limit the torque generated by the electric motor 300. The current limiting unit 120 outputs a current to the electric motor 300. As described above, the detection current (serving as an actual current) output from a current detector attached to the electric motor 300 or an amplifier that drives the electric motor 300 is input to the model unit 108. The model unit 108 calculates the estimated velocity ωe on the basis of the detection current and outputs the estimated velocity to the subtractor 110.

The inverse model unit 121 estimates a current command to which disturbance is added from the actual velocity ωr and outputs the estimated current command to the disturbance correction unit 122. The disturbance correction unit 122 takes a difference between the current command to which disturbance is added and the current command Iq and outputs the difference to the subtractor 119. The inverse model unit 121 and the disturbance correction unit 122 form a disturbance observer.

The optimal value receiving unit 113 receives the optimal time constant of acceleration/deceleration, the optimal velocity gain, the resonance frequency, the corrected inverse model, the velocity feedforward coefficient, and the torque limitation value from the host device 200A, stores the same in the storage unit 114, and changes the settings of the velocity control unit 104, the filter 105, the inverse model unit 121, the velocity feedforward unit 117, and the current limiting unit 120 on the basis of the optimal time constant of acceleration/deceleration, the optimal velocity gain, the resonance frequency, the corrected inverse model, the velocity feedforward coefficient, and the torque limitation value.

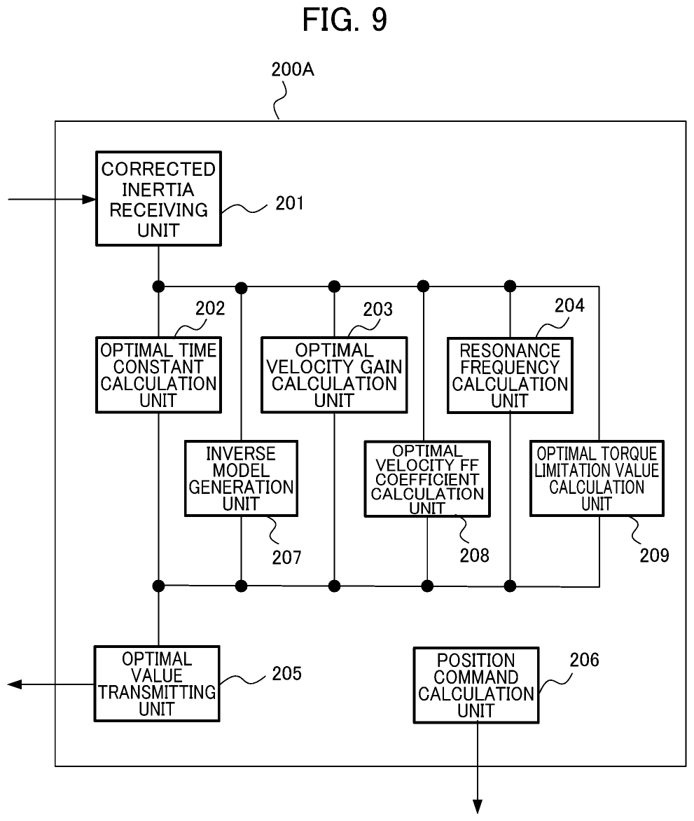

FIG. 9 is a block diagram illustrating a configuration of the host device 200A. As illustrated in FIG. 9, the host device 200A includes an inverse model correction unit 207, an optimal velocity feedforward coefficient calculation unit 208, and an optimal torque limitation value calculation unit 209 in addition to the constituent components of the host device 200 illustrated in FIG. 4.

The host device 200A may include one or a plurality of calculation units among the optimal time constant calculation unit 202, the optimal velocity gain calculation unit 203, the resonance frequency calculation unit 204, the inverse model correction unit 207, the optimal velocity feedforward coefficient calculation unit 208, and the optimal torque limitation value calculation unit 209. In this case, the controller 100A may include one or a plurality of units among the velocity control unit 104, the filter 105, the inverse model unit 121, the velocity feedforward unit (velocity FF unit) 117, and the current limiting unit 120. The host device 200A may be provided separately from a device including the position command calculation unit 206 similarly to the host device 200. In this case, the host device 200A does not include the position command calculation unit 206.

The corrected inertia receiving unit 201 receives the corrected inertia from the inertia correction unit 112 of the controller 100A, and the optimal time constant calculation unit 202, the optimal velocity gain calculation unit 203, the resonance frequency calculation unit 204, the inverse model correction unit 207, the optimal velocity feedforward coefficient calculation unit (optimal velocity FF coefficient calculation unit) 208, and the optimal torque limitation value calculation unit 209 receive the corrected inertia to calculate the optimal time constant of acceleration/deceleration, the optimal velocity gain, the resonance frequency, the inverse model coefficient, the optimal velocity feedforward coefficient, and the optimal torque limitation value, respectively. The optimal time constant calculation unit 202, the optimal velocity gain calculation unit 203, the resonance frequency calculation unit 204, the inverse model correction unit 207, the optimal velocity feedforward coefficient calculation unit 208, and the optimal torque limitation value calculation unit 209 output the optimal time constant of acceleration/deceleration, the optimal velocity gain, the resonance frequency, the inverse model coefficient, the optimal velocity feedforward coefficient, and the optimal torque limitation value to the optimal value receiving unit 113 via the optimal value transmitting unit 205, respectively.

Since the inverse model of the inverse model unit 121 is an inverse model of the transfer function of a control target including the electric motor 300 and the driven body, it is possible to set the inverse model on the basis of the corrected inertia. Since the coefficient of the velocity feedforward unit 117 is set to an inverse function (J·s+F)/Kt of the transfer function of the electric motor 300 and the driven body 400, it is possible to set the coefficient of the velocity feedforward unit 117 on the basis of the corrected inertia. The torque limitation value is determined so as to limit the output current of the current limiting unit 120 so that torque larger than necessary is not applied to the electric motor 300. Since torque T is represented by T=Kt·Iq=(J·s+F)·ωr, a limitation value serving as an upper limit acceleration is set on the basis of the corrected inertia.

In the control system 11, the optimal time constant calculation unit 202, the optimal velocity gain calculation unit 203, the resonance frequency calculation unit 204, the inverse model correction unit 207, the optimal velocity feedforward coefficient calculation unit 208, and the optimal torque limitation value calculation unit 209 provided in the host device 200A may be provided in the controller 100A. The corrected inertia receiving unit 201 and the optimal value transmitting unit 205 of the host device 200A are not necessary, and the optimal value receiving unit 113 of the controller 100A is not necessary. In this case, the inertia correction unit 112 of the controller 100A outputs the corrected inertia to the optimal time constant calculation unit 202, the optimal velocity gain calculation unit 203, the resonance frequency calculation unit 204, the inverse model correction unit 207, the optimal velocity feedforward coefficient calculation unit 208, and the optimal torque limitation value calculation unit 209. The optimal time constant calculation unit 202, the optimal velocity gain calculation unit 203, the resonance frequency calculation unit 204, the inverse model correction unit 207, the optimal velocity feedforward coefficient calculation unit 208, and the optimal torque limitation value calculation unit 209 calculate the optimal time constant of acceleration/deceleration, the optimal velocity gain, the resonance frequency, the inverse model, the optimal velocity feedforward coefficient, and the optimal torque limitation value and change the settings of the velocity control unit 104, the filter 105, the inverse model unit 121, the velocity feedforward unit 117, and the current limiting unit 120.

The controller 100A may include one or a plurality of calculation units among the optimal time constant calculation unit 202, the optimal velocity gain calculation unit 203, the resonance frequency calculation unit 204, the inverse model correction unit 207, the optimal velocity feedforward coefficient calculation unit 208, and the optimal torque limitation value calculation unit 209. In this case, the controller 100A may include one or a plurality of units among the velocity control unit 104, the filter 105, the inverse model unit 121, the velocity feedforward unit 117, and the current limiting unit 120.

The above-described embodiment is a preferred embodiment of the present invention. However, the scope of the present invention is not limited to the embodiment only but the present invention can be embodied in various modifications without departing from the spirit of the present invention.

The controller and the inertia evaluation method according to the present disclosure include the above-described embodiments and may employ various embodiments having the following configurations.

(1) A first aspect of the present disclosure provides a controller including: an electric motor (for example, an electric motor 300); an actual operation acquisition unit (for example, a rotary encoder 301) that acquires an actual operation of the electric motor; a model unit (for example, a model unit 108) that estimates an operation of the electric motor from a current value applied to the electric motor using a model including inertia of the electric motor and a driven body (for example, a driven body 400) connected to the electric motor; an operation signal input unit (for example, an operation signal input unit 106) that applies an operation signal to a control loop of the electric motor for a prescribed period; and an evaluation value calculation unit (for example, an evaluation value calculation unit 111) that calculates an evaluation value for evaluating the inertia on the basis of a difference between an actual operation and an estimated operation in the application period of the operation signal.

(2) In the controller according to (1), the evaluation value calculation unit may calculate the evaluation value on the basis of a value obtained by subtracting friction in the operation of the electric motor from the difference between the actual operation and the estimated operation.

(3) In the controller according to (2), the evaluation value may be a sum of an absolute value or a square sum of the difference between the actual operation and the estimated operation in the application period.

(4) In the controller according to any one of (1) to (3), the current value may be a current command to the electric motor or an actual current value.

(5) In the controller according to any one of (1) to (4), the actual operation and the estimated operation may be either one of an actual velocity and an estimated velocity, an actual position and an estimated position, or an actual acceleration and an estimated acceleration.

(6) The controller according to any one of (1) to (5) may further include an inertia correction unit (for example, an inertia correction unit 112) that corrects the inertia of the electric motor and the driven body on the basis of the evaluation value.

(7) The controller according to (6) may further include a changing unit that changes the settings of at least one of a time constant of an acceleration/deceleration command of the electric motor, a velocity gain, a velocity feedforward coefficient, an inverse model of an observer, an attenuation frequency of a filter, and a torque limitation value on the basis of the corrected inertia.

(8) The controller according to any one of (1) to (7) may further include a storage unit (for example, a storage unit 114) that stores at least one of: the inertia before correction; the corrected inertia; values before and after change of at least one of the time constant of the acceleration/deceleration command of the electric motor, the velocity gain, the velocity feedforward coefficient, the inverse model of the observer, the attenuation frequency of the filter, and the torque limitation value; and the evaluation value.

(9) In the controller according to any one of (1) to (8), the operation signal may be a sinusoidal signal having a frequency equal to or lower than a control band of the electric motor.

(10) Another aspect of the present disclosure provides a control system including: the controller (for example, a controller 100, 100A) according to (6); and a host device (for example, a host device 200, 200A) connected to the controller, wherein the host device includes: a receiving unit that receives corrected inertia transmitted from the controller; and a changing unit that changes settings of at least one of a time constant of an acceleration/deceleration command of the electric motor, a velocity gain, a velocity feedforward coefficient, an inverse model of an observer, an attenuation frequency of a filter, and a torque limitation value, which are inertia-dependent parameters, on the basis of the received inertia.

(11) Still another aspect of the present disclosure provides an inertia evaluation method of a controller that controls an electric motor, the method including: applying an operation signal to a control loop of the electric motor for a prescribed period; acquiring an actual operation of the electric motor; estimating an operation of the electric motor from a current value applied to the electric motor using a model including inertia of the electric motor and a driven body connected to the electric motor; and calculating an evaluation value for evaluating the inertia on the basis of a difference between an actual operation and an estimated operation in the application period of the operation signal.

### EXPLANATION OF REFERENCE NUMERALS

100, 100A: Controller
101: Subtractor
102: Position control unit
103: Subtractor
104: Velocity control unit
105: Filter
106: Operation signal input unit
107: Adder
108: Model unit
109: Integrator
110: Subtractor
111: Evaluation value calculation unit
112: Inertia correction unit
113: Optimal value receiving unit
114: Storage unit
115: Position feedforward unit
116: Adder
117: Velocity feedforward unit
118: Adder
119: Subtractor
120: Current limiting unit
121: Inverse model unit
122: Disturbance correction unit
200, 200A: Host device
201: Corrected inertia receiving unit
202: Optimal time constant calculation unit
203: Optimal velocity gain calculation unit
204: Resonance frequency calculation unit
205: Optimal value transmitting unit
206: Position command calculation unit
207: Inverse model unit generation unit
208: Optimal velocity feedforward coefficient calculation unit
209: Optimal torque limitation value calculation unit
300: Electric motor
400: Driven body

What is claimed is:

1. A controller comprising: an electric motor;
an actual operation acquisition unit that acquires an actual operation of the electric motor;
a model unit that estimates an operation of the electric motor from a current value applied to the electric motor using a model including inertia of the electric motor and a driven body connected to the electric motor;
an operation signal input unit that applies an operation signal to a control loop of the electric motor for a prescribed period; and
an evaluation value calculation unit that calculates an evaluation value for evaluating the inertia on the basis of a difference between an actual operation and an estimated operation in the application period of the operation signal.

2. The controller according to claim 1, wherein the evaluation value calculation unit calculates the evaluation value on the basis of a value obtained by subtracting friction in the operation of the electric motor from the difference between the actual operation and the estimated operation.

3. The controller according to claim 2, wherein the evaluation value is a sum of an absolute value or a square sum of the difference between the actual operation and the estimated operation in the application period.

4. The controller according to claim 1, wherein the current value is a current command to the electric motor or an actual current value.

5. The controller according to claim 1, wherein the actual operation and the estimated operation are either one of an actual velocity and an estimated velocity, an actual position and an estimated position, or an actual acceleration and an estimated acceleration.

6. The controller according to claim 1, further comprising: an inertia correction unit that corrects the inertia of the electric motor and the driven body on the basis of the evaluation value.

7. The controller according to claim 6, further comprising: a changing unit that changes settings of at least one of a time constant of an acceleration/deceleration command of the electric motor, a velocity gain, a velocity feedforward coefficient, an inverse model of an observer, an attenuation frequency of a filter, and a torque limitation value on the basis of the corrected inertia.

8. The controller according to claim 1, further comprising a storage unit that stores at least one of: the inertia before correction;
the corrected inertia;
values before and after change of at least one of the time constant of the acceleration/deceleration command of the electric motor, the velocity gain, the velocity feedforward coefficient, the inverse model of the observer, the attenuation frequency of the filter, and the torque limitation value; and
the evaluation value.

9. The controller according to claim 1, wherein the operation signal is a sinusoidal signal having a frequency equal to or lower than a control band of the electric motor.

10. A control system comprising: the controller according to claim 6; and a host device connected to the controller, wherein
the host device includes:
a receiving unit that receives corrected inertia transmitted from the controller; and
a changing unit that changes settings of at least one of a time constant of an acceleration/deceleration command of the electric motor, a velocity gain, a velocity feedforward, an inverse model of an observer, an attenuation frequency of a filter, and a torque limitation value, which are inertia-dependent parameters, on the basis of the received inertia.

11. An inertia evaluation method of a controller that controls an electric motor, the method comprising: applying an operation signal to a control loop of the electric motor for a prescribed period;
acquiring an actual operation of the electric motor;
estimating an operation of the electric motor from a current value applied to the electric motor using a model including inertia of the electric motor and a driven body connected to the electric motor; and
calculating an evaluation value for evaluating the inertia on the basis of a difference between an actual operation and an estimated operation in the application period of the operation signal.
